(19) United States
(12) Patent Application Publication
(10) Pub. No.: US 2026/0148171 A1
(43) Pub. Date: May 28, 2026

(54) DIGITAL PLATFORM TO ACCELERATE AND INCREASE THE EFFICIENCY OF THE ENERGY GENERATION PROJECT FINANCIAL DUE DILIGENCE PROCESS

(71) Applicant: Richard Deming, Farmville, NC (US)

(72) Inventor: Richard Deming, Farmville, NC (US)

(21) Appl. No.: 19/398,796

(22) Filed: Nov. 24, 2025

Related U.S. Application Data
(60) Provisional application No. 63/723,879, filed on Nov. 22, 2024.

(51) Int. Cl. G06Q 10/0635; G06F 40/205; G06Q 30/018

(52) U.S. Cl. CPC G06Q 10/0635; G06F 40/205; G06Q 30/018

(57) ABSTRACT

A computing platform performs automated due diligence by acquiring project scope information and documents, standardizing all data across all document types into a uniform format optimized for analysis and subjecting the data to repeated querying by large language model agents to triangulate it against a body of human content expertise coded into the platform. The platform compares variables with a project proforma, verifies permits by parsing permit data and cross checking a permitting authority portal, evaluates design completeness by detecting standards of readiness status, and measures the bankability of project agreements compared to industry standards. The platform computes environmental, social, and governance metrics, assesses counterparty risk and community sentiment using searches of public sources, and validates a reported capital stack by analyzing documents and applying industry standards thereto. The platform calculates risk metrics, applies weights to produce two scores, and generates a report that includes remediation steps.

### CROSS-REFERENCE TO RELATED APPLICATIONS

The present application claims priority to U.S. Provisional Application No. 63/723,879 filed Nov. 22, 2024, titled “DIGITAL PLATFORM TO ACCELERATE AND INCREASE THE EFFICIENCY OF THE ENERGY GENERATION PROJECT FINANCIAL DUE DILIGENCE PROCESS,” which is hereby incorporated by reference in its entirety.

### TECHNICAL FIELD

The embodiments generally relate to systems and methods for automated due diligence and risk scoring in energy generation project finance.

### BACKGROUND

Conventional due diligence platforms for energy generation projects organize source materials in electronic data rooms and provide user interfaces for uploading contracts, permits, technical drawings, environmental surveys, and financial models. Reviewers access folders, open individual documents, and log findings in separate worksheets or issue trackers. These platforms often support permissions, activity logs, and version tagging while relying on user actions to keep materials current and properly labeled.

Conventional financial analysis tools operate as spreadsheet models that accept inputs for capital costs, operating expenses, production forecasts, and revenue assumptions. Analysts adjust scenarios, calculate net present value and internal rate of return, and capture sensitivities to fuel prices, resource variability, or tariff changes. Teams exchange files over email or collaboration suites and record assumptions in cell notes or companion memos to preserve context.

Conventional legal and permitting workflows use document comparison utilities, redline editors, e.g., tracked changes functionality, and e-signature services to negotiate agreements and track permit and other applications and filings, e.g., regulatory in nature. Counsel reviews clauses, prepares markups, and circulates drafts, while project managers reference jurisdictional portals to confirm permit numbers, issuance dates, and inspection statuses. Environmental and social assessments typically rely on survey tools and document repositories that store questionnaires, consultant reports, and supporting evidence for later audit.

Conventional risk reporting compiles outputs from these tools into narrative summaries and slide decks. Stakeholders request role-specific views, and authors tailor content by filtering tables, copying charts, and annotating excerpts. These practices depend on manual alignment of document labels, units of measure, time horizons, and version identifiers, and they require coordination to maintain traceability, reproducibility, and timely delivery across developer, lender, insurer, and investor audiences.

Conventional risk reporting tools for project evaluation provide composite indices and narrative summaries that help organize findings, yet they often use fixed formulas and opaque criteria that limit quantitative comparability across technologies, project types, or industries. Users typically cannot adjust metric weights to reflect a specific investment thesis, and alternative weightings require manual replication of calculations outside the platform. Many systems apply inconsistent unit and time normalizations, which reduces portfolio level comparability. Drill down views, when available, tend to stop at category totals rather than linking each score to the exact contract or other clause, permit entry, drawing status, survey answer, or financial variable that produced it. These constraints make it difficult to generate a transparent, reproducible score that both aligns with a user defined framework and explains, at a granular level, the evidence that drives each category.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

The disclosed system automates due diligence for energy generation projects by acquiring project scope information and source materials from a dataroom, classifying the materials, and extracting and restructuring content into a standardized format. Artificial intelligence agents perform optical character recognition and other processing technologies to derive source materials, and, using numerous natural language processing requests from a variety of large language models, applies them against hard-coded guidelines derived from human content experts to ensure accuracy. This process is used to capture and triangulate revenue, duration, expense, and return and other project-related variables together with provenance links to their locations in source files. The standardized table normalizes units, currencies, time horizons and other project-related measures, values, and characteristics so that downstream analysis operates on consistent inputs without manual relabeling or reconciliation.

The disclosed system compares extracted variables with a project proforma to surface inconsistencies and gaps that would otherwise require spreadsheet crosschecks. Dedicated subprocesses verify permits by parsing permit attributes and crosschecking jurisdictional portals, evaluate design document completeness by detecting engineer stamps, title blocks, and readiness status, and measure agreements' bankability by comparing them to industry standard agreements. Additional subprocesses compute environmental, social, and governance metrics from survey responses and supporting materials, assess counterparty and community sentiment risk using a targeted web crawler and severity labeling, and validate a reported capital stack against available documentation. A community sentiment subprocess uses project location data to search public records plus mass and social media for mentions of the project that indicate local sentiment. The crawler interface handles access controls and captures citations, while a normalization routine standardizes entity names and filters by jurisdiction to reduce false positives. Each item is scored by severity using source type and recency, and the results roll up into subscores per entity and an aggregate project score.

A risk module aggregates results from the subprocesses into a plurality of risk metrics and computes two weighted scores. A first weighted score applies platform selected weights that can be updated over time, and a second weighted score applies user selected weights that reflect stakeholder preferences. These scores, along with narrative explanations and recommended remediation tasks that link back to contributing evidence, enable reviewers to focus on the highest impact items while maintaining traceability and reproducibility across teams.

The weighted scores are composed of general project scores and the risk module is capable of extensively drilling deeper into the underlying components of the scores and the documents themselves to provide clarity and justification for such scores.

A report module compiles the risk metrics, the two weighted scores, and remediation steps into a role ready report that is communicated to stakeholder devices. A user interface renders a dashboard that highlights top and bottom contributors to the scores, provides links into specific document passages, and supports recipient role filtering for sponsors, lenders, insurers, and other participants. In some embodiments a blockchain record stores a hash of the report and one or more scores to certify the output for later audit without revealing underlying confidential materials.

A system implementation organizes these capabilities into modules that run on one or more processors with memory, including a document module, an intelligence module, a risk module, a report module, a database engine, and a user interface module. A non-transitory computer readable medium can store instructions that cause a computing device to carry out the described operations. By integrating structured extraction, targeted subprocesses, weighted scoring, and evidence linked reporting, the disclosed system addresses functional shortcomings of conventional tools that rely on manual document handling, siloed analysis, and ad hoc compilation of results.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments; and

FIG. 3A-3E illustrates a method of implementing an AI powered digital platforms for assessing the viability and risk of projects, according to some embodiments.

FIG. 4 depicts an AI module workflow that operates within an application program to transform heterogeneous project materials into structured, machine-readable outputs, according to some embodiments;

FIG. 5 illustrates a risk module workflow that operates within the application program to transform evidence into machine computed scores, according to some embodiments; and

FIG. 6 depicts a CEARTscore workflow that integrates intake, automated analysis, user controls, and iterative rescoring, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A computing environment may include one or more servers, virtual machines, or container hosts coupled to user devices over a network. Each server may include processors, volatile and nonvolatile memory, network interfaces, and optional hardware accelerators. Program instructions stored in memory may configure the processors to execute an application that implements a document module, an intelligence module, a risk module, a scoring module, a report module, a database engine, a user interface module, and a crawler interface. The modules may execute on a single machine or across multiple nodes and may communicate through message queues or service calls over internal application programming interfaces (APIs). The system may expose authenticated endpoints to receive documents, retrieve analysis results, and deliver reports to stakeholder devices.

The document module may acquire a first set of information that includes a project scope and project-related documents. The module may connect to a dataroom using a secure API or web protocol, enumerate folders and files, and pull metadata such as filename, extension, size, checksum, and last modified timestamp. The module may maintain a manifest that records each retrieved item, a source locator, and a version identifier. The document module may apply a due diligence taxonomy and classify documents into types such as agreements, permits, design drawings, environmental or social materials, survey responses, and financial models. The module may further standardize all data derived from the taxonomy into a uniform format so that similar analyses may be conducted across all data. The module may write classification results to the database engine and may queue items for downstream processing by other modules.

The intelligence module may transform unstructured or semi-structured content into structured data stored in a standardized table, for example. The module may include natural language processing and optical character recognition subcomponents that operate on PDFs, word processor files, spreadsheets, images, and emails. The module may detect language, tokenize text, and segment documents into sections, paragraphs, and tables. For agreements, the module may extract party names, quantity requirements, insurance obligations, milestones, representations and warranties, assignment rights, delivery dates, security interests, operational and technical requirements and limitations, effective dates, performance requirements, term length and termination rights, pricing and payment terms, limitations of liability, indemnification provisions, events of default and remedies in connection therewith, and other terms. For financial models and proformas, the module may, for example, read cell ranges and equations and output revenue, expense, duration, return variables, etc. For permits, the module may parse permit number, issuing authority, status, issue date, expiration date, project address, related information, etc. For design drawings, the module may detect title blocks, sheet numbers, engineering discipline, the presence of a professional engineer stamp, etc. Each extracted variable may include provenance that points to a page number, cell reference, coordinate location, or character offsets that identify the source passage.

The standardized table may store variables in normalized units. The intelligence module may perform unit conversion for currency, energy, power, time, and distance using a configuration that maps detected units to canonical forms. The module may normalize dates to an ISO format and may convert monetary values into a base currency using a contemporaneous rate supplied by a rates service captured with a timestamp. The module may record normalization steps as metadata so a reviewer may reconstruct the original values and the transformations applied. The database engine may persist the standardized table and may index by document type, variable name, counterparty, and provenance to support efficient retrieval and traceability.

A proforma alignment subprocess may compare variables extracted from the standardized table to values in a project proforma. The subprocess may join records by semantic labels and by similarity of units and time horizons. For each matched variable, the subprocess may compute a delta and flag values outside a tolerance. For variables present in the proforma but not in the standardized table, the subprocess may mark gaps and create candidate remediation tasks. For variables present in the standardized table but absent from the proforma, the subprocess may identify potential omissions. The subprocess may store comparison results as a set of findings with links to source passages and a severity tag computed from rule weights.

A permits verification subprocess may analyze permit files and crosscheck a permitting-authority portal. The crawler interface may accept a jurisdiction identifier and perform a query using permit number, address, or owner name. Returned results may be normalized and deduplicated, and the subprocess may compare portal fields to parsed permit attributes. Mismatches or missing records may be labeled and included in a permit verification log. The subprocess may compute a permit coverage measure that accounts for required permit types listed in the project scope and the presence of current, expired, or pending entries. Permits may include interconnection applications, and federal, state and local filing requirements.

A design completeness subprocess may evaluate drawing sets and specifications. The intelligence module may confirm the presence of a professional engineer stamp by detecting signature blocks or seals and may check that a title block includes project name, location, and sheet details. The subprocess may test for indicators such as “Issued for Construction” or “Issued for Permit” and may record the most recent status per discipline. The subprocess may compute a completeness score based on detected status indicators, stamp presence, and coverage of required drawing categories.

An agreements bankability subprocess may route agreements to an internal or external redline analysis service using a secure API. The document module may convert agreements to supported formats, transmit the files, and receive machine-readable results that count and categorize issues such as indemnification, limitations of liability, performance requirements, insurance obligations, milestones, representations and warranties, term duration and termination rights, pricing and payment terms, quantity requirements, assignment rights, security interests, operational and technical requirements and limitations, delivery dates, and events of default and remedies in connection therewith. In other embodiments, count and categorized issues may be determined via one or models or agents configured to identify differences between one or more agreements and one or more models. The subprocess may normalize counts across documents and calculate a bankability measure based on critical and suggested items. Provenance may include clause identifiers and page locations for later review.

An environmental, social, and governance subprocess may operate on survey responses and supporting materials. The intelligence module may map survey items to one or more standards stored in the database engine, evaluate submitted evidence, and compute a metric for each category. The subprocess may store failed checks as findings that reference specific survey questions and attached documents. The metric may be aggregated at project level and written to the standardized table for use by the scoring module.

A counterparty risk subprocess may collect party identities from agreements and survey inputs and invoke the crawler interface to query public records and media sources. The crawler interface may manage rate limits, rotate credentials where allowed, and record citations for discovered items. A normalization routine may standardize entity names using alias tables and string similarity and may reduce false positives with jurisdiction filters. The subprocess may score each finding by severity based on source type and recency and may compute a counterparty risk subscore for each entity and for the project aggregate.

A community sentiment subprocess may collect project location from agreements and survey inputs and invoke the crawler interface to query public records and mass and social media sources for mentions of the project which reflect the sentiment of the community around it. The crawler interface may manage rate limits, rotate credentials where allowed, and record citations for discovered items. A normalization routine may standardize entity names using alias tables and string similarity and may reduce false positives with jurisdiction filters. The subprocess may score each finding by severity based on source type and recency and may compute a counterparty risk subscore for each entity and for the project aggregate. In some embodiments, the community sentiment subprocess may uses project location data to search public records plus mass and social media for mentions of the project to compute a community sentiment subscore.

A capital stack validation subprocess may parse funding documents, term sheets, and survey responses to confirm existence and documentation of reported funding sources. The subprocess may check that each source includes a named party, amount, instrument type, and a supporting document. For amounts that appear across multiple documents, the subprocess may reconcile totals and note any inconsistencies. The subprocess may generate a validation state per source and an overall confidence measure. The validation may compare capital stack variables to outside sources of information to discover if they fall within an industry standard range.

The risk module may collect outputs from the subprocesses and compute a plurality of risk metrics. Each metric may be defined by a formula or rule set that references specific fields in the standardized table and finding logs. The module may ensure that all metrics include provenance to the underlying evidence. The scoring module may compute two distinct weighted scores. A platform score may apply platform selected weights derived from subject matter guidance or prior outcomes, and a user score may apply user selected weights supplied through the user interface module. The scoring module may validate that weights sum to one and may compute weighted averages or other aggregations to produce the scores. The module may store both scores with a version identifier and a record of the exact weights used. The risk module may allow the user to drill down to sublevels or categories which are the bases for the scores, until they reach the actual documents or other source data to achieve complete understanding of the score.

The user interface module may render dashboards and detailed review screens on stakeholder devices. A score summary view may present the platform score and the user score along with top positive and negative contributors. A drill down view may show each risk metric, its value, the weight applied, and links to source evidence using provenance pointers. A remediation panel may list suggested actions generated by the subprocesses, such as obtaining a missing permit, supplying a stamped drawing, reconciling a proforma variable, or requesting a revised clause. The user interface module may enforce recipient role filters so a sponsor, lender, or insurer sees content tailored to that role while keeping the underlying evidence accessible through permissions.

The report module may compile an output that includes the plurality of risk metrics, the platform score, the user score, and recommended remediation steps. The module may render the report to a machine-readable format such as JSON or XML for integration and to a human readable format such as PDF or HTML for distribution. The module may include narrative explanations that cite the specific findings and variables that most influenced each metric, and may embed links that return the reader to the exact location in a document or table. The module may transmit reports to stakeholder devices using secure channels and may track delivery status for audit.

The database engine may manage persistent storage for documents, extracted variables, findings, weights, scores, reports, and user profiles. The engine may expose query interfaces that support filtering by project, document type, variable name, date range, and severity. The engine may maintain referential integrity between variables and their provenance and may store checksums for each file to detect changes. Access control lists may restrict read and write operations by user role. The engine may support point in time recovery so a completed diligence can be reproduced.

Optional certification may record a hash of a report and one or both scores to a blockchain. The report module may compute a cryptographic digest of the output payload, construct a transaction containing the digest and a timestamp, and submit the transaction to a sidechain or other ledger. The module may store the resulting transaction identifier with the report so an authorized party may later verify that the delivered report matches the certified digest without revealing confidential contents on the ledger.

The crawler interface may include adapters for public portals and media sites relevant to permitting, community sentiment, and counterparty checks. Each adapter may specify request parameters, result parsing rules, and compliance with site terms. The interface may deduplicate results using normalized entity names and citation hashes. The interface may export logs that include query terms, timestamps, and response snippets sufficient to support downstream review.

A role and weighting profile may allow a user to define weights for risk metrics. The user interface module may present a slider or numeric input for each metric and may show the effect of adjustments on the user score in real time. The scoring module may store each profile with a name and an effective date. The platform may optionally compute updated platform selected weights by aggregating user profiles across projects over a defined review period, and may store historical versions so past scores remain reproducible.

The system may employ background workers to process large document sets. A job queue may accept tasks such as OCR runs, agreement routing, portal checks, or counterparty searches. Workers may report progress and write intermediate results to the database engine. A project state machine may track phases such as intake, extraction, subprocess analysis, scoring, reporting, and delivery. The state machine may enable a dashboard to show current status and remaining tasks.

Error handling may include detection and recovery routines. If a document fails classification, the document module may flag it for manual review and record the reason. If the external redline analysis service returns an error, the agreements subprocess may retry according to a backoff policy and may annotate the report with a status note if the service remains unavailable. If a portal query times out, the permits subprocess may defer the check and continue processing other steps.

Security and privacy controls may protect project data. The system may encrypt documents at rest using an envelope key stored in a hardware security module and may use transport layer security for all network connections. Audit logs may record access and changes to variables, findings, weights, and reports. The system may support data retention policies that purge intermediate artifacts while retaining reports and provenance necessary for compliance.

An implementation path for a practitioner may begin with deploying a database engine and setting up schemas for documents, variables, findings, metrics, weights, scores, reports, users, and roles. The practitioner may implement the document module to connect to a dataroom and populate the manifest. The intelligence module may then extract variables and populate the standardized table with provenance and normalization metadata. The practitioner may implement each subprocess as a service that reads from the standardized table and writes findings and metric components. The scoring module may compute the platform score and user score from the metric components and stored weights. The report module may render and distribute the report and may optionally write a certification record. The user interface module may present dashboards, drill downs, and role filtered views. By following these steps and using the described data structures, APIs, and control flows, a person with an undergraduate understanding of software and computing hardware may configure a system that performs the claimed operations.

Various implementations of the invention involve the technical field of systems and methods for automated due diligence and risk scoring in energy generation project finance including extracting variables from the project-related documents into a standardized table using an artificial intelligence model; computing a plurality of risk metrics from document-specific subprocesses including proforma alignment, permits verification, design document completeness, agreements bankability, environmental, social, and governance compliance, counterparty risk, and capital stack validation; computing a first weighted score by applying platform-selected weights to the plurality of risk metrics; computing a second weighted score by applying user-selected weights to the plurality of risk metrics; generating a report comprising the plurality of risk metrics, the first weighted score, the second weighted score, and recommended remediation steps; and transmitting the report to one or more stakeholder devices and are therefore necessarily rooted in computer technology. For example, the aforementioned steps are inherently computer-based and cannot be performed in the human mind. The present invention amounts to more than merely implementing the generic computer as a tool to gather, analyze, and output data because the steps of the present method, system, or product improve the systems and methods for automated due diligence and risk scoring in energy generation project finance by providing an automated, machine-executed diligence workflow that acquires project files from a dataroom through APIs, applies optical character recognition and natural language processing to extract structured variables with provenance, normalizes units and currencies into a standardized table, and runs technical subprocesses that crosscheck permits against jurisdictional portals, evaluate design drawings for stamps and status markers, route agreements to a redline analysis service, assess environmental, social, and governance materials, and compute counterparty signals with a targeted web crawler. Purpose built data structures, indexes, and weighting profiles support deterministic scoring that aggregates metric outputs into platform and user scores stored with versioned parameters. These operations transform and verify data using concrete computational steps, specialized parsers, and network interfaces that interact with external systems, and they include cryptographic hashing for report certification. The solution does not merely organize human activity with generic hardware, because it performs content recognition, normalization, portal verification, and evidence linked scoring at machine scale using defined modules and algorithms that a human could not execute reliably or within practical time on raw documents. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

Implementations of the present invention include implementing (executing, running, or deploying) one or more artificial intelligence agents created and trained to act as specialists in different components of the projects and internally known as “bots”, (such as a “pro forma bot”, an “engineering bot”, etc.) on a computing device wherein the computing device executes the artificial intelligence agent's programmed function to utilize a large body of industry expert questions and insights to enhance understanding of risk variables used to compute the scores. These agents make multiple queries and are programmed to be agnostic to any particular large language model or machine learning libraries, and so any such model can be utilized moving forward. The computing device implements the artificial intelligence agent when it performs tasks like training, making predictions, applying the model to data, decision-making, classification, or generating outputs based on inputs. In particular, the speed at which an artificial intelligence agent analyzes and transforms data to effectuate the disclosed method, system, or product would involve large-scale, continuous transformation of such data. In a given project analysis, this can involve the agents making as many as a thousand API calls to various models comparing the answers to the body of human expertise, such as data relating to human expertise stored in a database, and each other before settling on the interpretation of the platform. As such, the present invention would be impossible to accomplish on pen and paper or in the human mind due to the volume of data being analyzed and transformed by the artificial intelligence model.

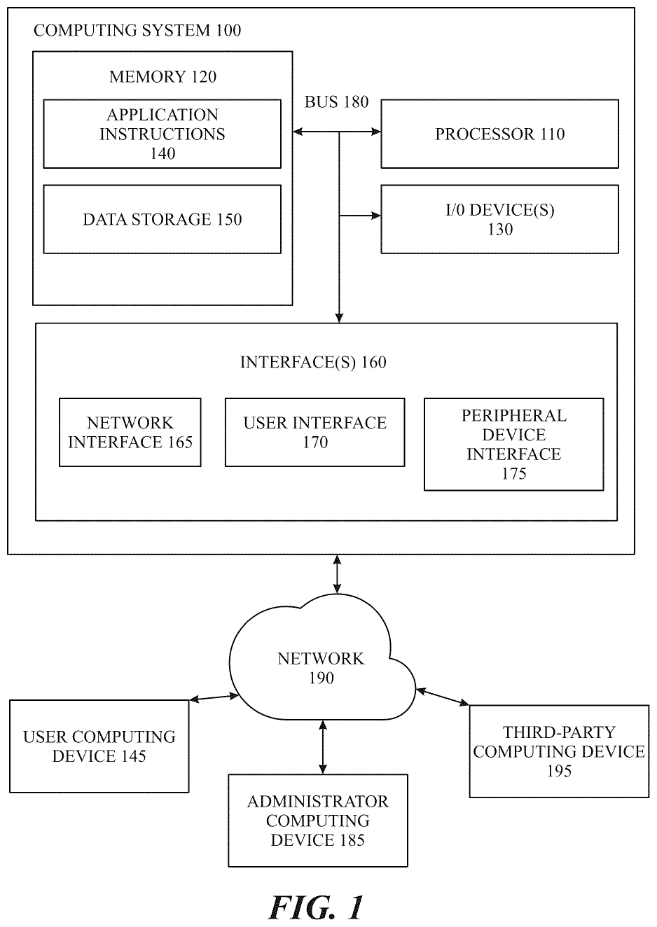

FIG. 1 illustrates an example of a computing system 100 that may provide the execution environment for implementing the processes and methods described herein. The computing system 100 may take various forms depending on deployment context, including but not limited to: a desktop or laptop computer, a tablet or smartphone, a server in a data center, a network appliance, a mainframe computer, a workstation, or a cloud-hosted virtual machine. In some embodiments, the computing system 100 may correspond to a distributed computing environment, such as a cluster of servers executing containerized workloads (e.g., Docker, Kubernetes), or an edge device integrated into Internet of Things (IoT) environments. In other embodiments, the computing system 100 may be embedded in another device, such as a vehicle infotainment unit, a medical diagnostic machine, an industrial robot controller, or a wearable computing device.

The computing system 100 includes one or more processors 110 operably coupled to a memory 120 via a system bus 180. The processor 110 may be implemented as a general-purpose central processing unit (CPU), a graphics processing unit (GPU), a tensor processing unit (TPU), a digital signal processor (DSP), or any combination thereof. In some embodiments, the processor 110 may be an application-specific integrated circuit (ASIC) optimized for a particular workload, a field-programmable gate array (FPGA), or a quantum or neuromorphic processor in advanced implementations. The processor 110 may include single-core, multi-core, or many-core configurations and may support hardware virtualization, multithreading, or parallel execution environments to optimize system performance.

The memory 120 may include volatile memory, nonvolatile memory, or a combination thereof. Volatile memory may include system RAM, cache memory, or high-bandwidth memory (HBM). Nonvolatile memory may include flash storage, solid-state drives (SSD), magnetic hard disk drives (HDD), optical storage devices, or persistent memory technologies such as Intel Optane. The memory 120 stores application instructions 140 for carrying out the functionalities described herein and data storage 150 for maintaining information related to system operations. The application instructions 140 may include code written in languages such as C, C++, Java, Python, Go, Rust, or JavaScript, as well as machine learning models trained using frameworks such as TensorFlow or PyTorch. The data storage 150 may contain structured information such as relational database records, unstructured data such as text or images, or real-time telemetry streams. In cloud-based embodiments, the memory 120 may represent scalable storage resources provisioned on-demand through Infrastructure-as-a-Service (IaaS) providers.

The computing system 100 may also include one or more input/output (I/O) devices 130. These devices may encompass visual output devices such as monitors, head-mounted displays, augmented reality (AR) glasses, or projectors; input devices such as keyboards, mice, touchscreens, styluses, or game controllers; and sensor devices such as microphones, cameras, depth sensors, biometric scanners, or environmental sensors. In industrial or medical environments, the I/O devices 130 may include robotic actuators, infusion pumps, or diagnostic imaging scanners. In vehicular environments, the I/O devices 130 may include in-cabin displays, steering sensors, and connected infotainment systems.

The computing system 100 further comprises one or more interfaces 160 that enable communication with other systems, users, or peripheral components. The network interface 165 allows the computing system 100 to exchange data with external systems across a network 190 using wired or wireless protocols. Example communication standards include Ethernet, Wi-Fi, Bluetooth, 5G, Long-Term Evolution (LTE), satellite communication, or emerging protocols such as Wi-Fi 7 or ultra-wideband (UWB). In some embodiments, the network interface 165 supports secure protocols such as HTTPS, TLS, or VPN tunneling to ensure authenticated and encrypted data transfer. The user interface 170 may include APIs, graphical user interfaces (GUIs), command-line interfaces (CLIs), or natural language interfaces enabled through speech recognition or chatbot systems. The peripheral device interface 175 enables connectivity with external hardware such as printers, external storage arrays, or specialized scientific equipment.

The network 190 represents any communication infrastructure capable of facilitating data exchange between computing entities. In some embodiments, the network 190 corresponds to a local area network (LAN) within a home or enterprise environment. In other embodiments, the network 190 may be a wide area network (WAN), a metropolitan area network (MAN), a peer-to-peer (P2P) communication mesh, or the global Internet. The network 190 may employ cloud orchestration layers, software-defined networking (SDN), or edge computing gateways. In high-security applications, the network 190 may implement firewalls, intrusion detection systems, or zero-trust architectures to protect transmitted data.

The computing system 100 is illustrated as being in communication with multiple external devices, including a user computing device 145, an administrator computing device 185, and a third-party computing device 195. The user computing device 145 may be a smartphone, tablet, laptop, or smart appliance configured to execute client-side applications or interact with system services. The administrator computing device 185 may be a workstation or remote management console configured to perform oversight functions such as monitoring, auditing, updating, or troubleshooting. The third-party computing device 195 may represent a partner system, vendor service, or external application interface that exchanges data with the computing system 100 via secure APIs. In cloud or SaaS embodiments, these devices may also include external microservices, data warehouses, or federated learning nodes.

In some embodiments, the computing system 100 may be deployed in a client-server model, where the computing system 100 acts as a backend server managing requests from client devices. In other embodiments, the computing system 100 may function within a cloud-native environment, operating as a microservice within a container orchestration platform. In edge deployments, the computing system 100 may be optimized for low-latency local processing, while synchronizing with centralized cloud infrastructure for data persistence and global coordination.

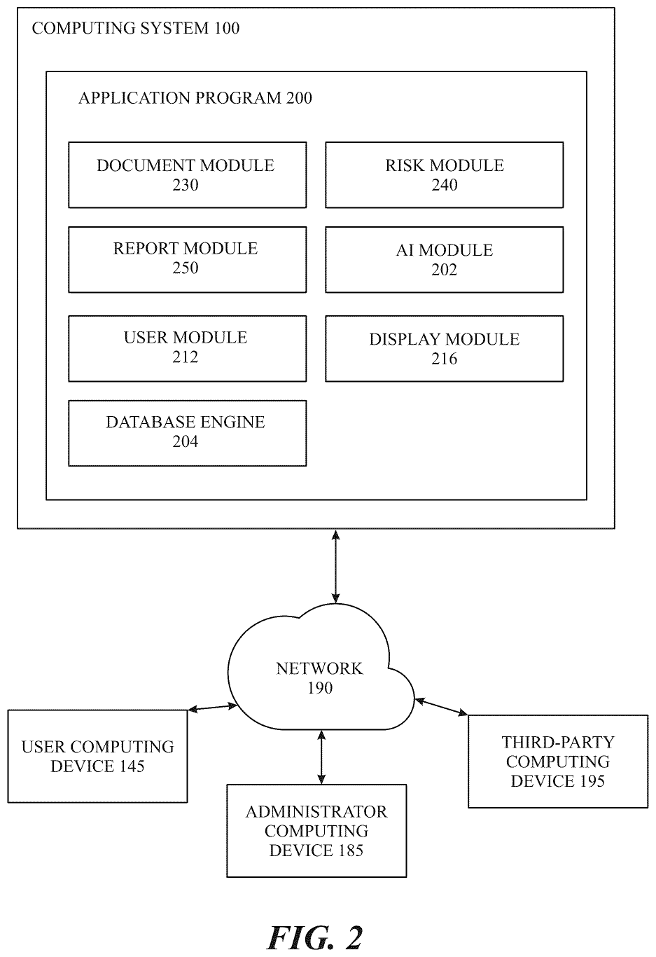

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a document module 230, a risk module 240, a report module 250, an AI module 202, a communication module 202, a database engine 204, a user module 212, and a display module 216.

In some embodiments, the document module 230 is configured to acquire, normalize, and manage project source materials used for automated diligence. The module may establish authenticated sessions with a dataroom or other repository through secure network protocols, enumerate files and folders, and pull metadata such as filename, size, checksum, version identifier, modified timestamp, and access permissions. The module may maintain a manifest that records a unique document identifier, a source locator, and a retrieval log so downstream processes can trace each data item to its origin.

In some embodiments, the document module 230 is configured to classify incoming files into predefined categories and prepare them for analysis. The module may apply lightweight natural language heuristics and filename patterns to assign taxonomy tags such as agreements, permits, design drawings, environmental and social materials, survey responses, and financial models. The module may convert files into analysis friendly formats by generating text layers for scanned PDFs using optical character recognition, extracting tabular data from spreadsheets, and rasterizing drawing sheets into image tiles with coordinate maps. The module may detect duplicates using content hashes and merge near duplicates using similarity measures while preserving lineage entries in the manifest.

In some embodiments, the document module 230 is configured to orchestrate document routing and provenance capture. The module may publish work items to internal queues that signal downstream components to perform extraction, verification, or scoring tasks, and it may include routing hints derived from taxonomy tags. For agreements, the module may transmit machine-readable copies to an external clause analysis service through a standards-based API and store returned identifiers so the risk workflow can retrieve counts of critical and suggested issues. In some embodiments, the document module 230 may communicate agreements to the AI module 202 for comparing against one or models or agents and producing a normalized score based on counts and categories of differences between one or more agreements and one or more models determined via the comparison. For permits, the module may expose parsed attributes such as permit number, issuing authority, and project address that a portal checker can use for cross references. Each routing action may write provenance entries that bind a work item to the document identifier, page range, and byte offsets where the triggering content appears.

In some embodiments, the document module 230 is configured to enforce version control and integrity guarantees. The module may compute cryptographic digests for each file, verify digests on reimport, and flag modifications that require reprocessing. The module may support lifecycle states including intake, validated, superseded, and archived, and it may apply rules that prevent downstream scoring from using superseded files. Access control lists stored with the manifest may govern which roles can read, annotate, or replace a document. The module may expose an audit report that lists retrieval events, format conversions, routing actions, and any errors encountered so that reviewers can reproduce the analysis path for a given project.

In some embodiments, the risk module 240 is configured to aggregate evidence produced across subprocesses and transform that evidence into machine computed risk metrics and weighted scores for an energy generation project. The module may execute as a stateless service behind an internal API and read normalized variables, findings, and provenance pointers from the database engine. The module may maintain a catalog of metric definitions that specify input fields, normalization functions, and rule expressions so that each metric computes deterministically from extracted data and cross checks. Each metric definition may include a version tag and a schema so historical results remain reproducible when definitions evolve.

In some embodiments, the risk module 240 is configured to compute document specific metrics for proforma alignment, permits verification, design completeness, agreements bankability, environmental, social, and governance compliance, counterparty risk, and capital stack validation. The module may map raw findings to standardized scales using techniques such as min max normalization, capped ratios, and severity bins so disparate inputs produce comparable values between zero and one. The module may apply time decay to dated evidence, penalize missing or unverifiable items, and compute confidence values that reflect extraction quality and source reliability. Each computed metric may store links to underlying passages, page coordinates, or cell ranges so reviewers can traverse from a score to the exact supporting evidence.

In some embodiments, the risk module 240 is configured to produce platform and user weighted scores from the plurality of metrics. The module may retrieve a platform weighting profile curated by administrators and may retrieve a user weighting profile supplied through the user module. The module may validate that weights sum to one, then multiply each metric by the corresponding weight and sum the products to compute two scores. The module may generate attribution vectors that quantify each metric's contribution to a score and may expose sensitivity values that show how a small weight change or metric change would shift the score. The module may store both scores with the metric vector, weighting profile identifiers, and a timestamp to preserve provenance.

In some embodiments, the risk module 240 is configured to calibrate and update platform selected weights over time. The module may collect anonymized, project level outcomes or expert committee adjustments and compute aggregate statistics that indicate systematic over weighting or under weighting of certain metrics. The module may generate a proposed weight revision using constrained optimization subject to guardrails that limit drift per review period. The module may record proposed and approved profiles with effective dates so previously issued reports remain traceable to the weights that produced them.

In some embodiments, the risk module 240 is configured to enforce quality controls and handle incomplete evidence. The module may detect missing metrics, apply fallback rules, and mark resulting scores with completeness flags. If upstream services fail to return results, the module may substitute conservative placeholders and create remediation entries that the report module can surface. The module may emit structured logs that capture inputs, intermediate values, and final outputs, which allows external auditors to independently recompute each metric and score from stored data.

In some embodiments, the risk module 240 is configured to expose results to downstream components and stakeholder devices. The module may publish metric values, platform and user scores, attribution vectors, and completeness flags through an internal API consumed by the report module and the display module. The module may support role-based filtering so sponsors, lenders, and insurers receive views aligned to their weighting profiles while preserving links back to the evidence that contributed to each metric.

In some embodiments, the report module 250 is configured to assemble machine generated diligence outputs into a consumable report that preserves traceability to underlying evidence. The module may query the database engine for normalized variables, findings, and provenance pointers and may request the plurality of risk metrics and weighted scores from the risk module 240. The module may construct a report object that binds metric values, attribution vectors, and completeness flags to their source documents, page coordinates, or cell ranges so a reader can navigate from any reported value to the exact passage that produced it.

In some embodiments, the report module 250 is configured to generate narrative explanations and remediation guidance from structured inputs. The module may evaluate metric deltas, tolerance breaches, and missing data indicators and may synthesize short paragraphs that explain what triggered each metric, where the supporting evidence resides, and what action may resolve a deficiency. The module may group related findings by topic and may produce cross references to the standardized table so reviewers can confirm units, currencies, and time horizons used during analysis.

In some embodiments, the report module 250 is configured to render the report in both machine-readable and human readable formats. The module may serialize the report object and provenance bindings as JSON or XML for integration, and may lay out a paginated document as PDF or HTML for distribution. A templating engine may inject project identifiers, platform and user scores, metric summaries, and role filtered sections that align with sponsor, lender, or insurer views. Charts and tables may be drawn from the same data bindings used to compute scores to avoid divergence between visuals and underlying values.

In some embodiments, the report module 250 is configured to manage delivery and access control. The module may apply role-based redaction rules, attach only those excerpts permitted for a recipient, and embed signed links that return a user to a controlled viewer displaying the precise evidence location referenced by a finding. The module may transmit reports to stakeholder devices over secure channels, record delivery timestamps and recipient acknowledgments, and update audit logs maintained by the database engine.

In some embodiments, the report module 250 is configured to version and certify outputs. The module may stamp each report with a profile identifier that captures metric definitions and weighting profiles used during computation and may include a digest of all embedded data. The module may compute a cryptographic hash of the final payload and write the hash and a timestamp to a ledger or other append only store. The module may retain the transaction identifier with the report so a later reader can verify that a presented copy matches the certified artifact without exposing confidential content.

In some embodiments, the report module 250 is configured to support localization, accessibility, and reproducibility. The module may format dates, currencies, and units according to a selected locale, generate text alternatives for charts and figures, and embed a reproducibility manifest listing document digests, extraction versions, and query parameters used during portal checks and counterparty searches. By coupling narrative text, structured bindings, and delivery controls, the module may provide a durable record of the analysis that downstream systems and human reviewers can rely on for diligence, underwriting, and compliance workflows.

In some embodiments, the AI module 202 is configured to convert heterogeneous project materials into structured, machine-readable data that downstream components can verify, score, and report. The module may execute as a service that accepts documents, images, spreadsheets, and emails from the document module 230 and returns typed fields with provenance links that identify the exact page, cell range, or coordinate span from which each field originated. The module may expose an internal API so the risk module 240 and report module 250 can request extractions on demand or retrieve cached results maintained by the database engine 204.

In some embodiments, the AI module 202 is configured to classify documents and segment their contents prior to extraction. The module may detect language, parse visual layout, and separate headers, paragraphs, tables, and signature blocks. For scanned files, the module may apply optical character recognition to generate text layers that preserve reading order and bounding boxes. The module may assign taxonomy tags such as agreements, permits, design drawings, environmental and social materials, survey responses, and financial models, and it may record a confidence score for each tag so low confidence items can be queued for optional human confirmation without halting automated processing.

In some embodiments, the AI module 202 is configured to extract domain specific fields using a hybrid of learned patterns and deterministic rules. For agreements, the module may identify party names, jurisdictions, effective dates, term lengths, pricing terms, and termination conditions and may return clause level anchors that allow reviewers to navigate to each supporting passage. For permits, the module may parse permit identifiers, issuing authorities, project addresses, status, and validity dates and may normalize formats so a portal checker can form consistent queries. For design drawings, the module may analyze title blocks, sheet identifiers, engineering discipline, and detect the presence of professional engineer stamps using image features aligned to drawing coordinates. For financial models and proformas, the module may read designated cell ranges and evaluate derived values such as revenue components, expense categories, durations, and return variables while preserving original units and formulas where available. As an example, the AI module 202 may operate in an agentic manner that orchestrates multiple cooperating agents to classify documents and build a uniform, queryable dataset. An external or internal process may extract usable data into an index while leaving unnecessary “noise” data behind, so that a new data base of more efficiently usable and accurate data remains for all additional needs. From this dataset, a series of agents which utilize general content expertise from a variety of external machine learning models (called bots, such as proforma bots, engineering bots, permit bots, etc.) begin to query the project using a body of human expertise coded into the system and updated from time to time. These queries are coordinated in a way that triangulates against each other, and against the human expertise embodied in the platform, to determine if a judgement about the project as it relates to risk or other information, is likely enough to safely offer the user. A coordinator agent may receive a document manifest and dispatch specialized agents that issue numerous targeted prompts and tool calls to one or more models, including, for example, a layout agent that may be configured for sectioning, a type agent that may be configured for taxonomy assignment with confidence, a field agent that may be configured for domain specific extraction, a normalization agent that may be configured for units, currencies, dates, and names, and a validator agent that may be configured for consistency checks. Each agent writes structured outputs to a shared schema that defines canonical variable names, data types, and allowed units so values from agreements, permits, drawings, surveys, and financial models align in the same standardized table. The workflow records provenance pointers for every field and stores normalization metadata that supports round trip reconstruction. By harmonizing semantics and formats at ingest, the system enables deterministic queries that return uniform and consistent results across projects and document types.

In some embodiments, the AI module 202 is configured to normalize and validate extracted values so cross checks operate on consistent inputs. The module may convert currencies, energy units, and time horizons to canonical representations using configuration tables stored in the database engine 204, and it may attach normalization metadata that describes each transformation. The module may deduplicate party names using alias tables and similarity measures and may disambiguate locations by combining parsed addresses with jurisdiction codes. Each normalized field may include a quality score that reflects source reliability, extraction confidence, and normalization completeness.

In some embodiments, the AI module 202 is configured to generate machine-actionable artifacts that drive the subprocesses used by the risk module 240. The module may emit a standardized table keyed by document type and variable name, a findings stream that highlights detected anomalies such as missing stamps or incomplete title blocks, and routing hints that direct agreements to a clause analysis service or permits to a portal verification routine. The module may maintain versioned extraction profiles so results remain reproducible when field definitions evolve, and it may cache intermediate representations to avoid recomputation across multiple scoring runs.

In some embodiments, the AI module 202 is configured to support explainability and incremental improvement without interrupting production use. The module may store feature summaries and rationale texts that describe why a passage matched a field definition, and it may expose these summaries to the display module 216 for reviewer inspection. When reviewers confirm or correct extracted fields, the module may record feedback that updates alias tables, threshold settings, or routing hints through a controlled promotion process. The module may track extraction quality metrics per document class and may emit alerts when drift exceeds tolerances so administrators can schedule profile updates.

In some embodiments, the AI module 202 is configured to operate securely and at scale. The module may process documents in isolated workloads, redact sensitive personal information before persisting intermediate artifacts, and restrict access to raw text and images according to role based policies coordinated with the user module 212. The module may parallelize OCR, layout analysis, and field extraction across worker nodes and may checkpoint progress so long running jobs survive restarts. By supplying classified, normalized, and provenance linked variables, the AI module 202 enables deterministic verification, scoring, and report generation performed by other components of the disclosed system.

In some embodiments, the communication module 202 is configured for receiving, processing, and transmitting a user command and/or one or more data streams. In such embodiments, the communication module 202 performs communication functions between various devices, including the user computing device 145 of FIG. 1, the administrator computing device 185 of FIG. 1, and a third-party computing device 195 of FIG. 1. In some embodiments, the communication module 202 is configured to allow one or more users of the system, including a third-party, to communicate with one another. In some embodiments, the communications module 202 is configured to maintain one or more communication sessions with one or more servers, the administrative computing device 185 of FIG. 1, and/or one or more third-party computing device(s) 195 of FIG. 1. In some embodiments, the communication module 202 may allow users and administrators to communicate with one another.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, and the like. The user module 212 may facilitate the creation of user's profiles for users, administrators, and others.

In some embodiments, the display module 216 is configured to display one or more graphic user interfaces, including, e.g., one or more user interfaces. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 displays information, notifications, and alerts to the user device which can be viewed and acknowledged by the user.

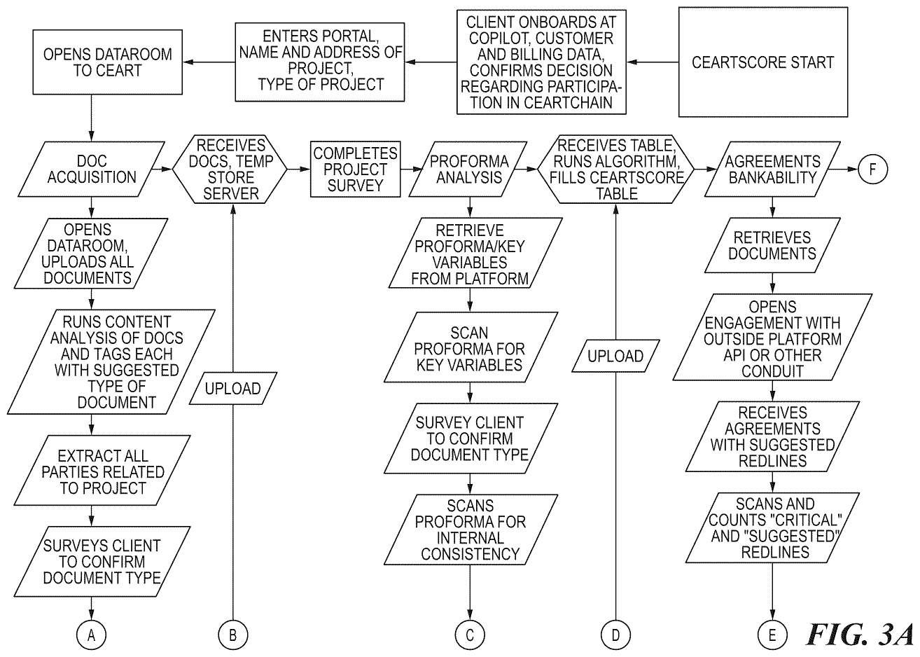

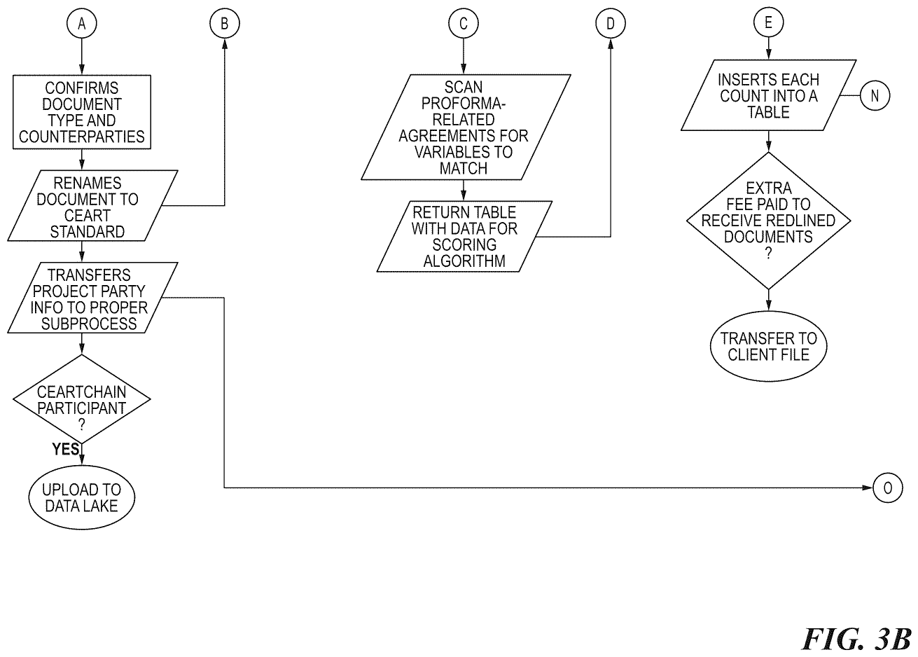

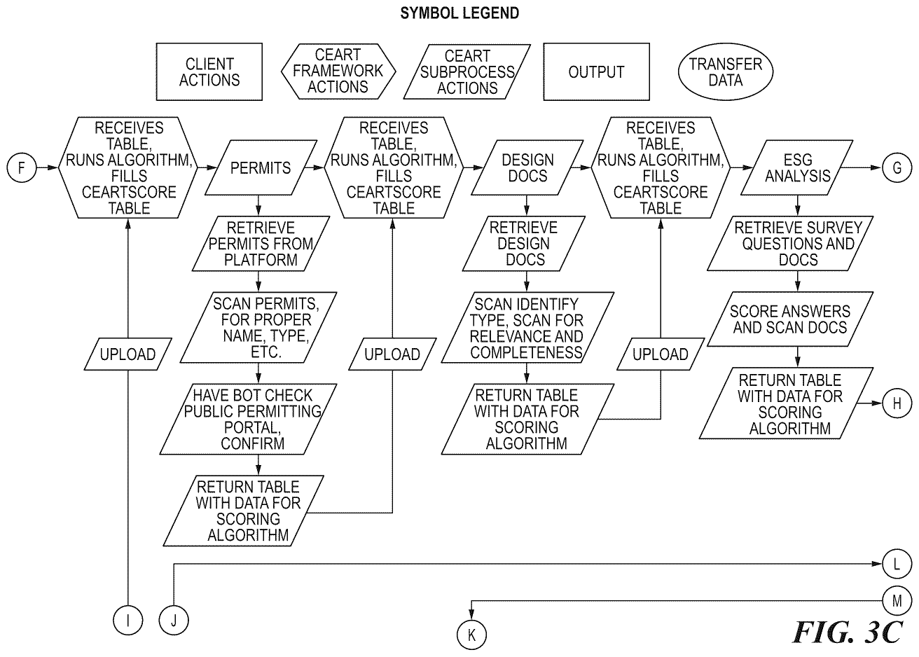

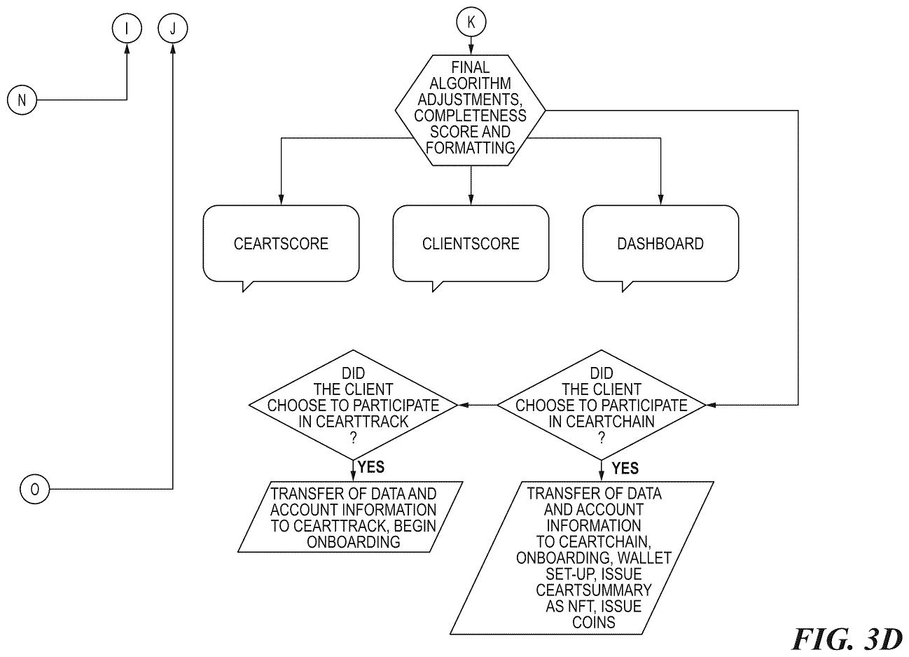

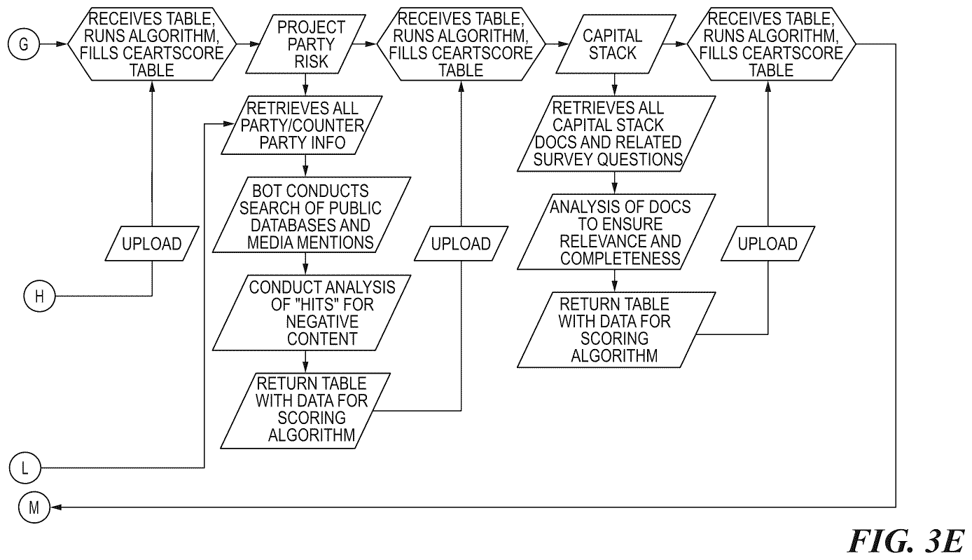

FIG. 3A illustrates a CEARTscore start sequence in which the application program prepares project intake, document normalization, and early subprocess routing. A client onboards at a cloud portal by supplying contact and billing data together with project identifiers, and the portal records consent regarding participation in CEARTchain. The client enters a dataroom name and an address and type of project, after which the document module 230 opens the dataroom and enumerates available folders. The portal uploads all contents and the server records receipt of files. The AI module 202 performs document acquisition by running content analysis on each file and assigning a suggested document type tag. The workflow extracts parties related to the project and prompts the client to confirm or correct a document type suggestion, which provides supervised feedback that improves later routing. Connector A indicates continuation to additional intake operations.

The workflow collects survey data used by downstream checks. A diligence survey is completed and transmitted to the server, and the AI module 202 retrieves proforma key variables either from the uploaded proforma or, when configured, from a modeling platform through a standards based interface. The AI module 202 scans the proforma for key variables, and the risk module 240 reviews those variables for consistency as part of proforma analysis. Connector B indicates a continuation of the proforma comparison.

FIG. 3A further depicts initialization of agreements bankability. The system opens an engagement with an external clause analysis service through a secure conduit and retrieves agreements and related documents from the dataroom. The external service returns machine-readable counts of critical and suggested redlines, and the workflow scans and counts those redlines for agreements. Connector E indicates that the agreements analysis continues in a later figure, and connector F returns results to the CEARTscore table. Throughout the sequence the AI module 202 writes normalized variables and provenance into a CEARTscore table, and the risk module 240 executes an analysis algorithm that will later combine additional subprocess outputs. Connector C advances to checks for internal consistency and other subprocesses, and connector D denotes additional uploads that supplement the document set.

FIG. 3B depicts a continuation of the CEARTscore workflow in which uploaded materials are normalized and routed to subprocesses for scoring and archival. From connector A, a reviewer confirms a suggested document type and identified counterparties. The system renames each document to a CEART standard and transfers project and counterparty information to the appropriate subprocess, such as proforma alignment, permits verification, design completeness, or agreements bankability. The workflow determines whether the client has elected to participate in CEARTchain. When participation applies, the system uploads normalized artifacts and metadata to a data lake for certified storage while preserving links to the working project file. From connector B, the system returns a standardized table that includes variables used by the scoring algorithm. From connector C, the AI module 202 scans proforma related agreements for variables expected to match those in the proforma and records detected matches or gaps. From connector D, the risk module 240 ingests the standardized table for metric computation. For agreements bankability, counts of critical and suggested redlines received from an external clause analysis may be inserted into a table, as indicated by connector E and step N. In some embodiments, agreements bankability is determined by comparing agreements against one or models or agents and producing a normalized score based on counts and categories of differences between one or more agreements and one or more models determined via the comparison. When an optional extra fee authorizes delivery of marked agreements, the workflow transfers redlined documents to the client file. Connector O denotes continuation to subsequent figures that present additional subprocesses and reporting.

FIG. 3C illustrates a continuation of the CEARTscore workflow in which permits, design documents, and ESG materials are processed as coordinated subprocesses that return machine-readable tables for scoring. From connector F, the permits subprocess receives a table and runs an algorithm that populates the CEARTscore table with parsed attributes and findings. The system retrieves permit records from a permitting-authority platform and scans permit files for identifiers, issuing authorities, project names, addresses, status, and expiration dates. A public portal checker confirms the existence of corresponding entries, and results are uploaded. The permits subprocess returns a table with data for the scoring algorithm, as indicated by connector I.

The design document subprocess receives a table and runs an algorithm that contributes to the CEARTscore table. The system retrieves design documents, scans title blocks and drawing sheets to identify discipline, sheet identifiers, status indicators, and the presence of professional engineer stamps, and evaluates coverage for completeness. The system uploads intermediate results and returns a table with data for the scoring algorithm, as indicated by connector J.

The ESG subprocess receives a table and runs an algorithm that fills the CEARTscore table with survey-based metrics. The system retrieves survey questions and supporting documents, scores answers against selected standards, and scans attached evidence for corroboration. The system uploads the results and returns a table with data for the scoring algorithm, as indicated by connector H. Output from these three subprocesses transfers to downstream data handling, and connector G denotes aggregation for subsequent steps, while connectors K, L, and M indicate continuation to later figures that integrate additional metrics and produce composite scores.

FIG. 3D illustrates downstream aggregation and publication operations that follow the subprocesses shown previously. From connector K, the application performs final algorithm adjustments, applies completeness scoring, and formats outputs for presentation and storage. The risk module 240 produces two composite values labeled CEARTscore and CLIENTscore, and the display module 216 prepares a dashboard that highlights these scores together with underlying contributors. The user can establish multiple CLIENTscores with different weighting to test different scoring scenarios. The workflow evaluates optional participation choices for two external programs. A branch checks whether the client elected to participate in CEARTtrack; when selected, the system transfers relevant data and account information to an onboarding interface for that program. A second branch checks whether the client elected to participate in CEARTchain; when selected, the system transfers data and account information to a wallet onboarding interface and records a summary of the CEARTscore on a certification ledger. Connectors I and J indicate returns to earlier subprocess lanes when additional inputs arrive, connector N denotes continuation to subsequent project actions, and connector O denotes progression to later figures that cover delivery and archival.

FIG. 3E illustrates continuation of the CEARTscore workflow for project party risk and capital stack validation. From connector G, a project party risk subprocess receives a table and runs an algorithm that fills the CEARTscore table with counterparty findings. The subprocess retrieves party and counterparty information collected during intake and agreements processing, and a crawler interface conducts targeted searches of public databases and media sources on the internet. The subprocess analyzes returned items for identity matches, adverse events, and recency, applies penalties for negative or missing content, and associates each finding with provenance links. The subprocess uploads intermediate artifacts and returns a table containing normalized fields and severity values for consumption by the scoring algorithm, as indicated by connector H.

FIG. 3E also shows a capital stack subprocess that receives a table and runs an algorithm contributing to the CEARTscore table. The subprocess retrieves capital stack documents and related survey responses, parses party names, instrument types, amounts, and commitments, and evaluates relevance and completeness against expected funding sources. The subprocess uploads analysis results and returns a table with machine-readable variables that the scoring algorithm uses to compute a capital stack metric. Connectors L and M indicate integration of these subprocess outputs with subsequent steps that generate composite scores and prepare dashboard and report outputs.

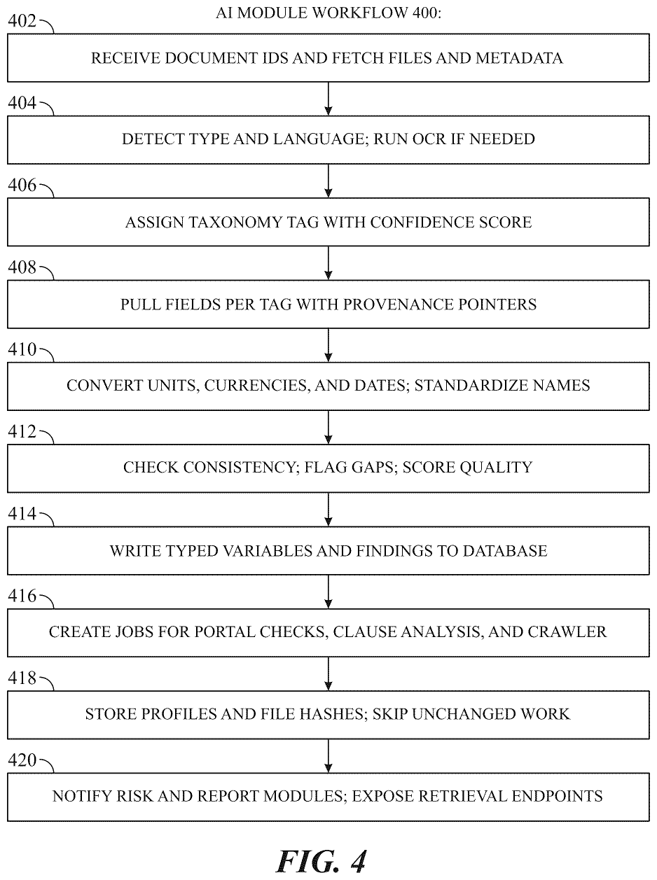

FIG. 4 depicts an AI module workflow 400 that operates within an application program to transform heterogeneous project materials into structured, machine-readable outputs. At step 402, the AI module 202 receives document identifiers and project context from the document module 230 and fetches corresponding files and metadata over authenticated network connections. At step 404, the AI module 202 detects file type and language and, when needed, performs optical character recognition to create a searchable text layer while preserving page coordinates. At step 406, the AI module 202 assigns a taxonomy tag to each file with an associated confidence score so downstream routines can select tag specific pipelines. At step 408, the AI module 202 executes the tag specific extraction pipeline to pull fields with provenance pointers that reference page numbers, cell ranges, or coordinate spans within the source.

At step 410, the AI module 202 converts extracted values into normalized forms by applying unit, currency, and date conversions and by standardizing party names and locations using alias and jurisdiction tables stored in the database engine 204. At step 412, the AI module 202 evaluates internal consistency, flags gaps or unreadable regions, and assigns a quality score that reflects extraction confidence and source reliability. At step 414, the AI module 202 writes typed variables and associated findings to the database engine 204 and indexes entries by project, document type, variable name, and provenance so other components can retrieve them deterministically.

At step 416, the AI module 202 emits routing jobs that trigger auxiliary checks, including portal verification for permits, clause analysis for agreements, and targeted searches via a crawler interface for counterparty discovery. At step 418, the AI module 202 stores versioned extraction profiles and hashes of source files and uses those records to skip recomputation when neither the file nor the profile has changed. At step 420, the AI module 202 publishes completion events that notify the risk module 240 and the report module 250 that standardized data is available and exposes retrieval endpoints for metric computation and report binding. The sequence of steps in workflow 400 enables automated intake, normalization, validation, persistence, routing, caching, and publication of evidence linked variables used by other modules in the system.

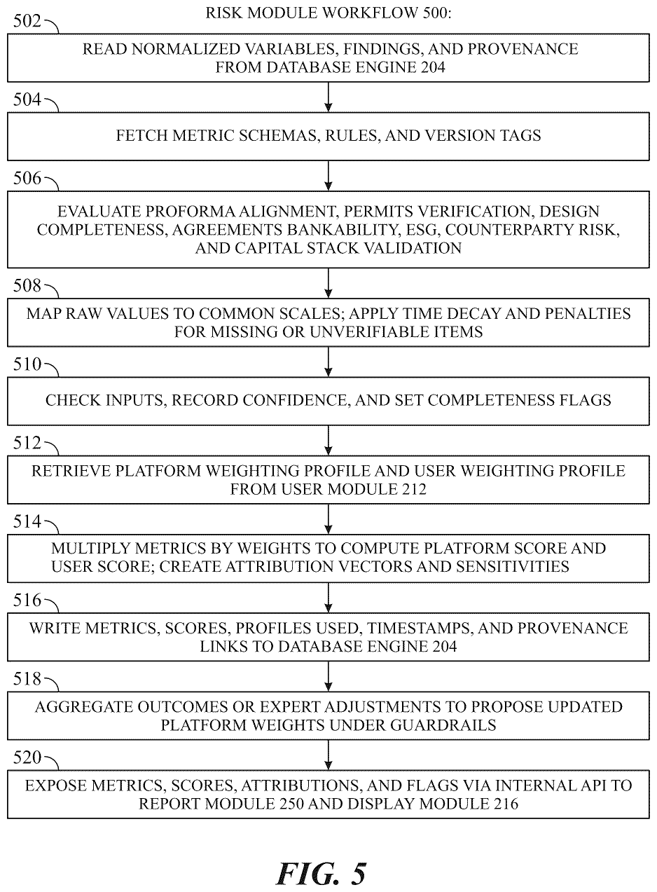

FIG. 5 illustrates a risk module workflow 500 that operates within the application program to transform evidence into machine computed scores. At step 502, the risk module 240 reads normalized variables, findings, and provenance from the database engine 204. At step 504, the risk module 240 fetches metric schemas, rules, and version tags that define how each metric will be computed so that results remain reproducible across updates.

At step 506, the risk module 240 evaluates document specific subprocess outputs to compute metrics for proforma alignment, permits verification, design completeness, agreements bankability, environmental, social, and governance compliance, counterparty risk, and capital stack validation. At step 508, the risk module 240 maps raw values to common scales, applies time decay to dated evidence, and assigns penalties for missing or unverifiable items. At step 510, the risk module 240 checks input integrity, records confidence values, and sets completeness flags that characterize coverage of the underlying evidence.

At step 512, the risk module 240 retrieves a platform weighting profile and a user weighting profile from the user module 212. At step 514, the risk module 240 multiplies metric values by the respective weights to compute a platform score and a user score and creates attribution vectors and sensitivities that quantify contributions from individual metrics. At step 516, the risk module 240 writes metrics, scores, identifiers of the profiles used, timestamps, and provenance links back to the database engine 204. At step 518, the risk module 240 optionally aggregates project outcomes or expert adjustments to propose updated platform weights subject to guardrails that limit drift. At step 520, the risk module 240 exposes metrics, scores, attributions, and flags through an internal API for consumption by the report module 250 and the display module 216.

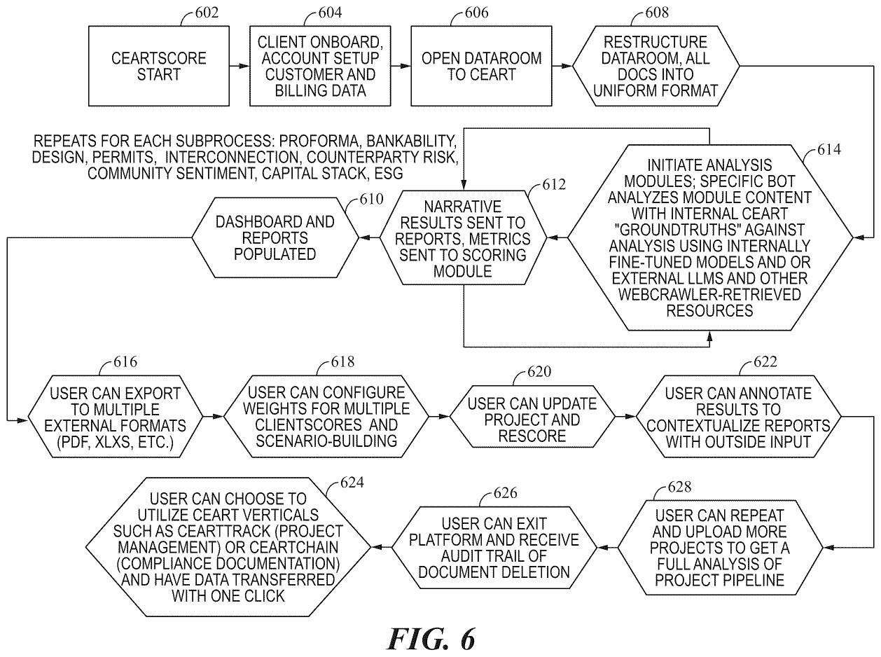

FIG. 6 a depicts a CEARTscore workflow in which components may exchange data through repeatable scoring cycles. At 602, a project context may be initialized and assigned a globally unique job identifier that downstream tables and queues reference. At 604, onboarding may persist account, customer, and billing fields in tenant records within the database engine 204 and may create role entries for access control and consent flags for optional programs. At 606, the document module 230 may open the designated dataroom through a secure API, enumerate a manifest of files and folders with checksums, MIME types, size, and last modified timestamps, and stage download tasks with retry policies. At 608, the AI module 202 may restructure all retrieved materials into a uniform format by applying OCR where needed, extracting text and tables, rasterizing drawings with coordinate maps, and writing a standardized table that defines canonical variable names, data types, and units. Each variable may include provenance pointers to page numbers, cell ranges, or coordinates together with a source hash and an extraction profile version so later rescoring reproduces the exact state.

At 614, the application may initiate an analysis pipeline implemented as agentic workers that consume batches from the standardized table. Agents may include proforma alignment, permits verification, design completeness, agreements bankability, ESG, community sentiment, counterparty risk, and capital stack validation. The community sentiment agent may use project geography to query public and media sources through a crawler interface that manages rate limits, credential rotation where allowed, and de-duplication; findings may be normalized by entity aliases and jurisdiction filters and scored by recency and source type. Each agent may append findings and metric inputs with timestamps, worker identity, and immutable provenance to the database engine 204. At 612, a narrative generator may convert metric inputs into short explanations that cite the exact evidence and may transmit both narratives and machine-readable metric vectors to the risk module 240. The risk module 240 may validate completeness flags, map raw values to common scales, apply penalties for missing or unverifiable items, and compute CEARTscore using platform weights and CLIENTscore using a selected user weighting profile from the user module 212; it may persist both scores together with attribution vectors, profile identifiers, and a reproducibility manifest. At 610, the display module 216 may populate a dashboard and report views that expose the scores, top contributing metrics, sensitivities, and drill downs to the underlying passages.

At 616, the workflow may repeat for each subprocess by scheduling idempotent jobs keyed by the project identifier and file digests so only changed inputs trigger recomputation. At 618, the report module 250 may export outputs to external formats such as PDF, JSON, and CSV directly from the persisted vectors and bindings to avoid divergence between visuals and data. At 620, the user module 212 may allow a user to configure multiple CLIENTscore weighting profiles and perform scenario building; selecting a profile may trigger the risk module 240 to recompute CLIENTscore without rerunning extraction. At 621, a user may update project inputs, upload new documents, or edit survey responses; the system may invalidate affected cache entries by hash and requeue only the impacted agents before a rescore. At 622, users may annotate and contextualize reports; annotations may persist as separate records linked to provenance while leaving evidence immutable. At 624, a user may connect to CEARTtrack or other project tracking by enabling a normalized event feed that maps remediation tasks to external identifiers. At 626, a user may exit while preserving an audit trail by instructing the report module 250 to compute a cryptographic digest of the final report and scores, store the digest with a timestamp in an append only ledger, and lock the project for read only access. At 628, the pipeline may iterate as additional materials arrive, returning control to 614 to incorporate updates while versioned artifacts in the database engine 204 maintain reproducibility of CEARTscore and CLIENTscore for any prior issuance.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A computer-implemented method for automated due diligence of an energy generation project, the method comprising:
receiving, by a computing device, a first set of information comprising a project scope and project-related documents retrieved from a dataroom;
classifying, by an artificial intelligence model, the project-related documents into document types and extracting variables into a standardized table;
comparing extracted variables with variables obtained from a project proforma to detect inconsistencies;
verifying permits referenced in the project scope by parsing permit data, crosschecking a permitting-authority portal based on capability, and flagging missing or stale entries;
determining a completeness state of design documents;
determining an agreements bankability metric comprising comparing agreements against one or models;
determining an environmental, social, and governance metric by evaluating survey responses and supporting documents against defined standards;
identifying counterparty risk indicators from public records and media sources and correlating the indicators with entities in the project-related documents;
identifying community sentiment indicators from public records and media sources and correlating the indicators with entities in the project-related documents;
validating a capital stack by confirming existence and documentation of reported funding sources and comparing the reported funding sources to industry standards;
calculating a plurality of risk metrics based on the comparing, verifying, determining, identifying, and validating;
computing a first weighted score by applying platform-selected weights to the plurality of risk metrics;
computing a second weighted score by applying user-selected weights to the plurality of risk metrics;
generating a report comprising the plurality of risk metrics, the first weighted score, the second weighted score, and recommended remediation steps; and
communicating the report to a user device.

2. The method of claim 1, wherein the artificial intelligence model performs at least one of natural language processing, optical character recognition, or multiple cooperating artificial intelligence agents to extract revenue, duration, expense, and return variables and to populate the standardized table.

3. The method of claim 1, wherein verifying permits comprises parsing permit files to confirm project owner identity, project address, issue dates, and permit type and performing an automated lookup against a jurisdictional public portal to confirm corresponding permit identifiers.

4. The method of claim 1, wherein determining the completeness state of design documents comprises detecting presence of a professional engineer stamp, detecting a title block containing project name and location, and detecting a status indicator specifying ready-for-construction.

5. The method of claim 1, wherein determining the agreements bankability metric comprises comparing agreements against one or models and producing a normalized score based on counts and categories of differences between one or more agreements and one or more models determined via the comparing.

6. The method of claim 1, wherein identifying the counterparty risk indicators comprises extracting party names and jurisdictions from agreements, querying public legal and regulatory databases and media sources using a web crawler, and labeling discovered records by severity to form a counterparty risk subscore.

7. The method of claim 1, further comprising rendering, on the user device, a dashboard to display highest and lowest contributing risk metrics and to display the first weighted score and the second weighted score with links to document-level evidence.

8. A system comprising: one or more processors; and memory storing instructions that, when executed by the one or more processors, cause the system to implement an application comprising:
a document module configured to retrieve project-related documents from a dataroom, classify the documents, and extract variables into a standardized table;
an intelligence module configured to perform natural language processing and optical character recognition to support extraction and to parse permits, agreements, design documents, and environmental, social, and governance documents;
a risk module configured to compute a plurality of risk metrics and to compute a first weighted score using platform-selected weights and a second weighted score using user-selected weights;
a report module configured to generate a report comprising the plurality of risk metrics, the first weighted score, the second weighted score, and recommended remediation steps and to communicate the report to a user device;
a database engine configured to persist the standardized table, the plurality of risk metrics, and the report; and
a user interface module configured to render a dashboard highlighting top and bottom contributors to the first weighted score and the second weighted score.

9. The system of claim 8, wherein the document module is further configured to route agreements to an external redline analysis service and to receive machine-readable counts of critical and suggested redlines for use by the risk module.

10. The system of claim 8, wherein the intelligence module is further configured to verify permits by parsing permit attributes and cross-checking a permitting authority portal using a network interface.

11. The system of claim 8, wherein the risk module is further configured to compute a counterparty risk subscore by extracting party identities from agreements, invoking a web crawler to search public records and media, and weighting adverse findings by severity.

12. The system of claim 8, wherein the report module is further configured to generate narrative explanations that identify missing documents, suspected inconsistencies, and corrective actions that increase at least one of the first weighted score or the second weighted score.

13. The system of claim 8, wherein the user interface module is further configured to present remediation tasks with links to specific underlying documents and locations within the documents that contributed to the remediation tasks.

14. The system of claim 8, wherein the risk module is further configured to update the platform-selected weights used in the first weighted score by calculating an aggregate of user-selected weights across completed projects during a defined review period.

15. A non-transitory computer-readable storage medium storing instructions that, when executed by one or more processors, cause a computing device to perform operations comprising:
retrieving project-related documents from a dataroom;
extracting variables from the project-related documents into a standardized table using an artificial intelligence model;
computing a plurality of risk metrics from document-specific subprocesses including proforma alignment, permits verification, design document completeness, agreements bankability, environmental, social, and governance compliance, counterparty risk, and capital stack validation;
computing a first weighted score by applying platform-selected weights to the plurality of risk metrics;
computing a second weighted score by applying user-selected weights to the plurality of risk metrics;
generating a report comprising the plurality of risk metrics, the first weighted score, the second weighted score, and recommended remediation steps; and
transmitting the report to one or more stakeholder devices.

16. The non-transitory computer-readable storage medium of claim 15, wherein the operations further comprise updating the platform-selected weights for the first weighted score using an aggregate of user-selected weights captured over a defined review period.

17. The non-transitory computer-readable storage medium of claim 15, wherein the operations further comprise writing a blockchain record representing at least the first weighted score and a hash of the report.

18. The non-transitory computer-readable storage medium of claim 15, wherein the operations further comprise generating narrative explanations mapping individual risk metrics to missing documents, detected inconsistencies, and suggested corrective actions.

19. The non-transitory computer-readable storage medium of claim 15, wherein transmitting the report comprises sending recipient-role filtered views respectively to a project sponsor device, a financing stakeholder device, and an insurance stakeholder device.

20. The non-transitory computer-readable storage medium of claim 15, wherein extracting variables further comprises normalizing units, currencies, and time horizons across the project-related documents and storing provenance metadata linking each extracted variable to a document location.
